(19) United States
(12) Patent Application Publication
(10) Pub. No.: US 2013/0228195 A1
(43) Pub. Date: Sep. 5, 2013

(54) SYSTEM AND METHOD FOR CLEANING PANEL

(71) Applicant: SAMSUNG DISPLAY CO., LTD., Yongin-City (KR)

(72) Inventors: Sung-Han KIM, Hwaseong-si (KR); Choon-Soo PARK, Seoul (KR)

(73) Assignee: SAMSUNG DISPLAY CO., LTD., Yongin-City (KR)

(21) Appl. No.: 13/742,493

(22) Filed: Jan. 16, 2013

(30) Foreign Application Priority Data
Mar. 5, 2012 (KR) 10-2012-0022137

(51) Int. Cl. B08B 3/02; B08B 1/02

(52) U.S. Cl. CPC B08B 3/022; B08B 1/02
USPC 134/6; 134/30; 15/302

(57) ABSTRACT

Disclosed are a cleaning system for a panel, which includes a steam sprayer for spraying steam on the panel and a cooling water sprayer for spraying cooling water on the panel, and a cleaning method of a panel performing cleaning the panel through steam spraying and cooling water spraying. While the panel is sprayed with steam, a foreign substance attached to the panel may be temporarily swollen or experience a phase change. After the process of spraying the steam, the panel is sprayed with cool water, through which the foreign substance is cooled and condensed, which may cause weakening of the coupling force with the panel.

### CROSS-REFERENCE TO RELATED APPLICATIONS

This application makes reference to, incorporates the same herein, and claims all benefits accruing under 35 U.S.C. §119 from an application earlier filed in the Korean Intellectual Property Office on 5 Mar. 2012 and there duly assigned Serial No, 10-2012-0022137.

### BACKGROUND OF THE INVENTION

1. Field of the Invention

The present disclosure relates to a cleaning system including a steaming apparatus and a cooling apparatus and a cleaning method using the same, and particularly, to system and method for cleaning a display panel.

2. Description of the Related Art

Recently, as demand for high-quality display device such as a liquid crystal display (LCD), a plasma display panel (PDP), an organic light emitting diode (OLED) display, and the like increases, a research to develop the high-quality display device has been actively performed.

Since the high-quality display device is delicately manufactured, even a minute contamination may cause a defect. Accordingly, cleaning process became very important in the manufacture of the high-quality display device. That is, a cleaning process of removing impurities existing on the panel or a substrate is an important factor in preventing occurrence of the defect of the display device.

Particularly, in the case of a sensitive display device such as an active matrix organic light emitting diode (AMOLED) display which has recently been in the limelight, since a SiO₂ film is formed on the surface of the display panel, the display device has relatively weak strength of the surface. Accordingly, when the cleaning is performed by methods such as polishing using a polishing belt, brushing, blade cleaning, and the like, which are general cleaning methods, since the cleaning strength is strong, there is a problem in that the SiO₂ film of the display panel peels off or a scratch occurs on the surface. Meanwhile, in order to prevent damage to the display surface, such as the scratch or the peel-off, if the cleaning strength is weakened, there is a problem in that a sufficient cleaning effect as much as desired cannot be obtained.

Accordingly, development of cleaning system and method is required so as to efficiently remove impurities or foreign substances without causing damage to the surface of the display panel.

### SUMMARY OF THE INVENTION

The present disclosure has been made in an effort to provide a cleaning system and a cleaning method capable of efficiently removing impurities or foreign substances which exist on the surface of the display panel without causing damage to the surface of the display panel.

The present disclosure has been made in an effort to provide a system for cleaning a panel including a steaming apparatus and a cooling apparatus.

The present disclosure has been made in an effort to provide a method for cleaning a panel including a steaming and a cooling method.

The present disclosure has been made in an effort to provide a cleaning system and a cleaning method capable of efficiently removing substances which exist on the surface of a display panel, without causing the damage to the surface thereof.

An exemplary embodiment of the present disclosure provides a cleaning system for a panel, including: a panel supporter on which the panel is loaded; and a cleaning head disposed above the panel supporter, in which the cleaning head includes a steam sprayer for spraying steam on the panel and a cooling water sprayer for spraying cooling water on the panel.

The temperature of the steam sprayed from the steam sprayer may be 50° C. to 100° C. The temperature of the cooling water sprayed from the cooling water sprayer may be 0° C. to 20° C.

The cleaning head may further include at least one of a cleaning liquid sprayer, a belt cleaner, and a brush.

The cleaning system for a panel may further include a water tank, in which the steam sprayer may be connected to the water tank, and the steam sprayer may include a pump for drawing water from the water tank, a heating apparatus for heating the water supplied from the pump to generate steam, and a steam spraying nozzle for spraying the steam.

The cleaning system for a panel may further include an air sprayer for apply air to the panel.

The air sprayer may include a blade for emitting air, and the air may be sprayed through the blade for air spraying.

The panel may be a display panel. The display panel may be an organic light emitting diode display panel.

Another exemplary embodiment of the present disclosure provides a cleaning method for a panel, including: loading the panel on a panel supporter; spraying steam on the panel; spraying cooling water on the panel after the spraying steam; and processing the panel by a cleaning member.

The spraying of the cooling water may be continuously performed after performing the spraying of the steam.

The temperature of the steam sprayed in the spraying of the steam may be controlled to about 50° C. to 100° C. The spray time of the steam sprayed in the spraying of the steam may be controlled to about 1 second to 20 seconds.

The temperature of the cooling water sprayed in the spraying of the cooling water may be controlled to about 0° C. to 20° C. The spray time of the cooling water sprayed in the spraying of the cooling water may be controlled to about 1 second to 10 seconds. The spray pressure of the cooling water sprayed in the spraying of the cooling water may be controlled in the range of 0.5 kgf/cm² to 1.5 kgf/cm².

The processing of the panel by the cleaning member may include spraying a cleaning liquid, belt cleaning using a belt cleaner, brushing using a brush, or combinations thereof.

The cleaning method may further include spraying air on the panel. The air may be sprayed through the blade for air spraying.

The panel may be a display panel. The display panel may be an organic light emitting diode display panel.

According to the exemplary embodiment of the present disclosure, a foreign substance to be cleaned is first processed by steam, and then cooled. When the foreign substance is swollen by processing the steam to the foreign substance to be cleaned, immediately cooled, arid rapidly cooled, releasing force and hardness of the foreign substance can be weakened and the foreign substance can be easily removed in a subsequent additional cleaning process. In the case where the cleaning is performed by only the steam, the foreign substance is cleaned, but a foreign substance spot occurs. However, according to the method proposed herein, the cleaning may be performed without the foreign substance spot.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic diagram of a cleaning system for a panel according to an exemplary embodiment of the present disclosure, which schematically shows that a display panel is cleaned by using the cleaning system.

FIG. 2 schematically shows that a foreign substance attached to a panel is swollen and then condensed by spraying cooling water after spraying steam on the panel, according to an exemplary embodiment of the present disclosure, to cause a phase change.

FIG. 3 schematically shows the configuration of a cleaning head in a cleaning system according to an exemplary embodiment of the present disclosure.

FIG. 4 shows a flowchart for cleaning processes according to an exemplary embodiment of the present disclosure.

FIG. 5 shows a structure and elements of a steam sprayer coupled to a water tank.

### DETAILED DESCRIPTION OF THE INVENTION

Hereinafter, the exemplary embodiments of the present disclosure will be described in detail with reference to the accompanying drawings. However, the scope of the present disclosure is not limited to the following exemplary embodiments and drawings.

For reference, respective components and shapes thereof were schematically drawn or exaggeratedly drawn in the accompanying drawings for easy understanding. Components that perform the same or similar functions are represented by the same reference numerals on the drawings.

A structure of a cleaning system for a panel according to an exemplary embodiment of the present disclosure is schematically shown in FIG. 1.

Hereinafter, for the unification of the description, detailed exemplary embodiments for implementing the present disclosure will be described based on a cleaning system and a cleaning method for cleaning a display panel as a panel.

The cleaning system for a panel, according to the exemplary embodiment shown in FIG. 1, includes a panel supporter 200, on which a panel 100 is loaded, and a cleaning head 300 disposed above the panel supporter 200. The cleaning head 300 includes a steam sprayer 400 for spraying steam 401 and a cooling water sprayer 500 for spraying cooling water 501. In the exemplary embodiment shown in FIG. 1, the cleaning head 300 further includes a belt cleaner 610 in addition to the steam sprayer 400 and the cooling water sprayer 500.

The steam sprayer 400 is an apparatus for spraying steam 401 on the panel. A foreign substance attached to the panel may be temporarily swollen or may experience a phase change by being exposed to the steam.

Water is used for supplying the steam in the steam sprayer. Among the water, particularly, deionized water (DI water) may be used. As another example, the steam made by using water mixed with a cleaning material may be used and for example, the steam made by evaporating a cleaning liquid in which a surfactant and a chemical cleaning agent as the cleaning material are mixed with water may also be used.

The cleaning system for a panel includes a water tank (not shown) for storing water required for cleaning.

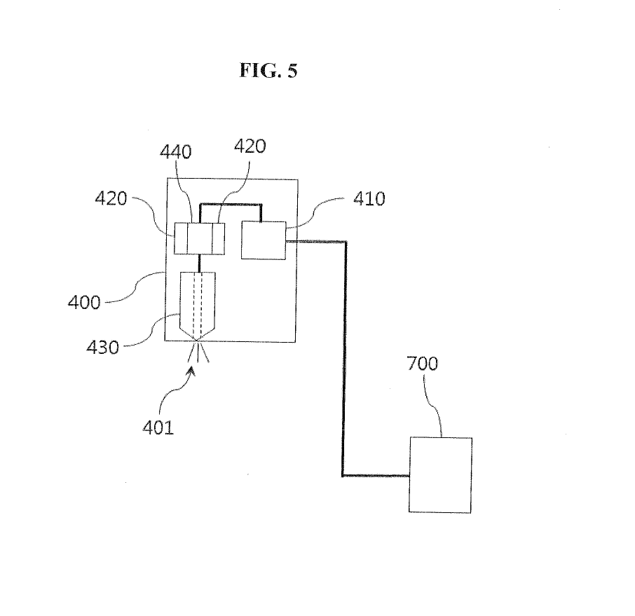

As shown in FIG. 5, the steam sprayer 400 is connected with the water tank 700 and may include a steam spraying nozzle 430 for spraying the steam. In detail, the steam sprayer 400 may include a pump 410 for pumping water from the water tank to supply the water to the steam sprayer 400, a heating apparatus 420 for heating the water supplied from the pump to form steam, and a steam spraying nozzle 430 for spraying the steam. In addition, the steam sprayer 400 may include a water chamber 440 to heat water to generate steam and to supply the steam to the steam spraying nozzle 430.

The steam is sprayed on the panel 100 loaded on the panel supporter 200 through the steam spraying nozzle.

The steam sprayer 400 may further include a pressure controller (not shown) for controlling pressure of the steam. As an example of the pressure controller, a pressure controller for controlling pressure of the steam, which is sprayed from the steam nozzle by supplying air, may be used. In the cleaning system for a panel according to the exemplary embodiment, the spray pressure of the steam is 1 bar or less.

The steam sprayer 400 is connected with a separate controlling unit (not shown) to control a spray time of the steam. For example, a controlling unit controlling opening and closing of the steam spraying nozzle is included to control the opening and closing of the steam spraying nozzle, thereby controlling the spray time of the steam.

The spray time of the steam may vary according to a kind of foreign substance and a kind of panel, and the steam is sprayed for a time period, in which the foreign substance attached to the panel can be sufficiently swollen or cause the phase change. Since the degree of the phase change varies according to each kind of foreign substance, the spray time of the steam may be separately controlled as necessary. In the exemplary embodiment, the display panel is exemplified as the panel, but considering characteristics of general foreign substances attached to the display panel, the spray time of the steam may be about 1 to 20 seconds.

The steam sprayer 400 may further include a temperature measuring member for measuring a temperature of the steam and a temperature controlling unit for controlling the temperature of the steam. For example, the temperature controlling unit is connected to the temperature measuring member to measure the temperature of the steam and may control the temperature of the steam by controlling the heating apparatus.

The temperature of the steam may vary according to a kind of foreign substance and may be a temperature of the steam capable of phase-changing and swelling the foreign substance. Since the temperature of the phase change varies according to each kind of foreign substance, the temperature of the steam may be controlled as necessary. According to the exemplary embodiment of the present disclosure, the temperature of the steam sprayed from the steam sprayer may be 50° C. to 100° C. Considering kinds, states, and the like of foreign substances attached to the panel, those skilled in the art may control the temperature of the steam within the temperature range.

The cooling water sprayer 500 is an apparatus for spraying cooling water 501 on the panel, where the steam has been sprayed thereon, to cool the foreign substance heated by the steam, that is, a cleaning object. The foreign substance which is swollen or phase-changed by the steam spraying is cooled by adding the cooling water to be condensed so that the coupling force with the panel may be weakened.

The cooling water sprayer 500 is disposed together with the steam sprayer 400 so that the cooling water is sprayed immediately after the stream is sprayed to the panel and as a result, the foreign substance, which is heated by the steam so as to be swollen or phase-changed, is cooled.

Water of a low temperature is sprayed from the cooling water sprayer 500. In other words, the temperature of the cooling water 501 discharged from the cooling water sprayer 500 is lower than the temperature of the steam 401 discharged from the steam sprayer 400. Among the water, particularly, deionized water (DI water) may be used. Meanwhile, water mixed with another cleaning material may be used and for example, a cleaning liquid, in which a surfactant and a chemical cleaning agent as the cleaning material are mixed with water, may also be used.

Although not shown in FIG. 1, the cooling water sprayer 500 is connected to a water tank storing water and may include a cooling water spraying nozzle for spraying the cooling water. The cooling water sprayer 500 may include a pump for pumping water from the water tank.

Herein, the cooling water sprayer 500 and the steam sprayer 400 may be connected to the same water tank. After the water is pumped from the water tank, only the water supplied to the steam sprayer is heated to be made into the steam.

The cooling water sprayer 500 may further include a pressure controlling apparatus (not shown) for controlling a pressure of the cooling water that is sprayed. As an example of the pressure controlling apparatus, an apparatus for controlling the pump which supplies the water of the water tank to the spraying nozzle to control the pumping pressure may be used.

In the cleaning system for a panel according to the exemplary embodiment, the spray pressure of the cooling water may be in the range of 0.5 to 1.5 kgf/cm².

The cooling water sprayer 500 may include a controlling unit (not shown) to control a spray time of the cooling water. For example, a control unit controlling opening and closing of the cooling water spraying nozzle is included to control the opening and closing of the cooling water spraying nozzle, thereby controlling the spray time of the cooling water.

The spray time of the cooling water may vary according to the kind of foreign substance and the kind of panel, and the cooling water is sprayed for a time period, in which the swollen or phase-changed foreign substance can be sufficiently condensed. The spray time of the cooling water may be separately controlled according to the kind of foreign substance and the kind of panel. In the exemplary embodiment, the display panel is exemplified as the panel, but considering characteristics of general foreign substances attached to the display panel, the spray time of the cooling water may be about 1 to 10 seconds.

The cooling water sprayer 500 may further include a temperature measuring member for measuring a temperature of the cooling water. The cooling water sprayer 500 may further include an insulating member for preventing the temperature of the cooling water from rising or a cooling member for keeping the temperature of the cooling water at a predetermined temperature or less.

The temperature of the cooling water sprayed from the cooling water sprayer 500 may vary according to a kind of foreign substance and the temperature of the cooling water becomes a temperature at which the phase-changed or swollen foreign substance may be cooled. According to the exemplary embodiment of the present disclosure, the temperature of the cooling water sprayed from the cooling water sprayer 500 may be 0° C. to 20° C. Considering the kinds, states, and the like of foreign substances attached to the panel, those skilled in the art may control the temperature of the cooling water within the temperature range.

In the exemplary embodiment shown in FIG. 1, the cleaning head 300 includes a belt cleaner 610 in addition to the steam sprayer 400 and the cooling water sprayer 500.

In detail, the cleaning head 300 may further include at least one of a cleaning liquid sprayer, a belt cleaner, and a brush in addition to the steam sprayer 400 and the cooling water sprayer 500 and as an example, the cleaning system for a panel shown in FIG. 1 includes the belt cleaner 610.

The belt cleaner 610 polishes the surface of the panel by using a belt wound round rollers to perform the cleaning. The belt cleaner is referred to as a “polishing belt part”. The belt cleaner may be any one of the polishing belts for cleaning which are generally used in the art.

Although not shown in the drawing, the cleaning head 300 may include a cleaning liquid sprayer. For example, the cleaning liquid sprayer may be disposed inside or outside the belt cleaner 610, and may be separately disposed from the belt cleaner 610. The cleaning liquid sprayer may spray cleaning liquid on the panel while the belt cleaning is performed by the belt cleaner 610. Efficiency in the belt cleaning may be improved by spraying the cleaning liquid on the panel. The cleaning liquid may be sprayed immediately before the belt cleaning is performed by the belt cleaner 610.

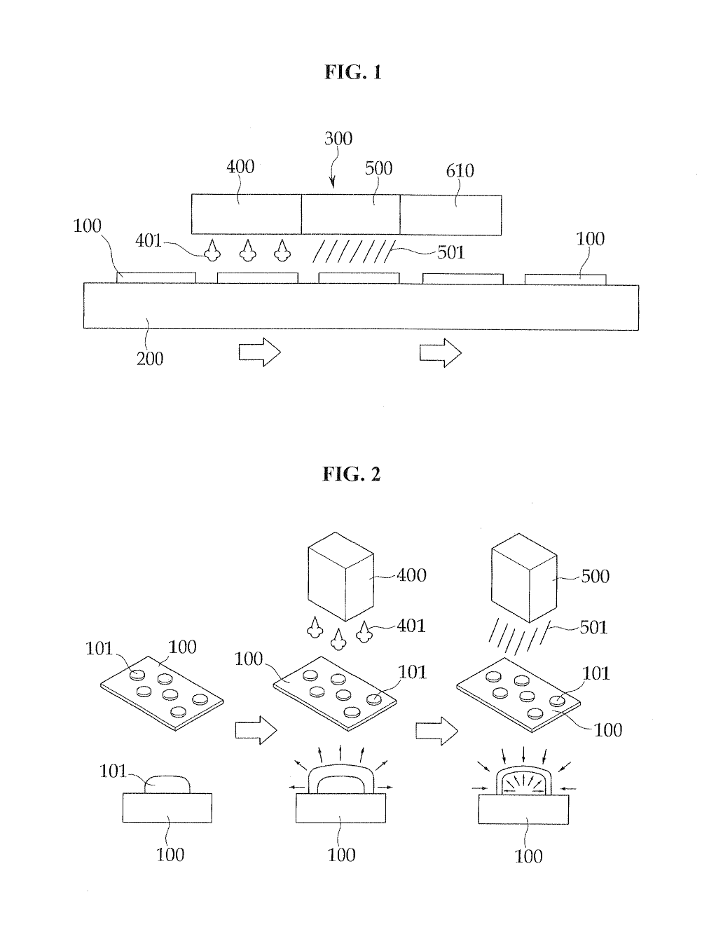

FIG. 2 schematically shows that a foreign substance 101 attached to the panel 100 is swollen and then condensed by spraying cooling water after spraying steam on the panel to cause a phase change.

As shown in FIG. 2, when the foreign substance 101 is attached to the panel 100, the attached foreign substance is not easy to be completely removed by general cleaning processes. Accordingly, in the exemplary embodiment of the present disclosure, the foreign substance 101 is swollen by applying steam 401 to the foreign substance 101 attached to the surface of the panel 100. In this case, the steam 401 is applied so that a temperature of the foreign substance 101 rises up to a glass transition temperature of the foreign substance 101.

Subsequently, the foreign substance 101 is condensed by being exposed to cooling water 501 discharged from the cooling water sprayer 500. As described above, when the foreign substance 101 is swollen at a high temperature by the steam 401 and then is condensed by the cooling water 501, the foreign substance may be removed without a trace, which can be caused by the general cleaning processes, due to property modification of the foreign substance or weakening of the surface tension.

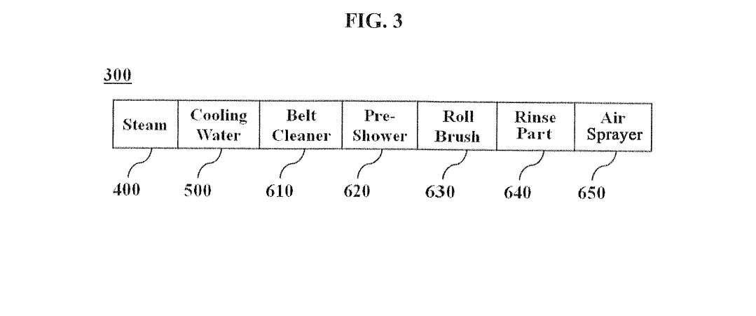

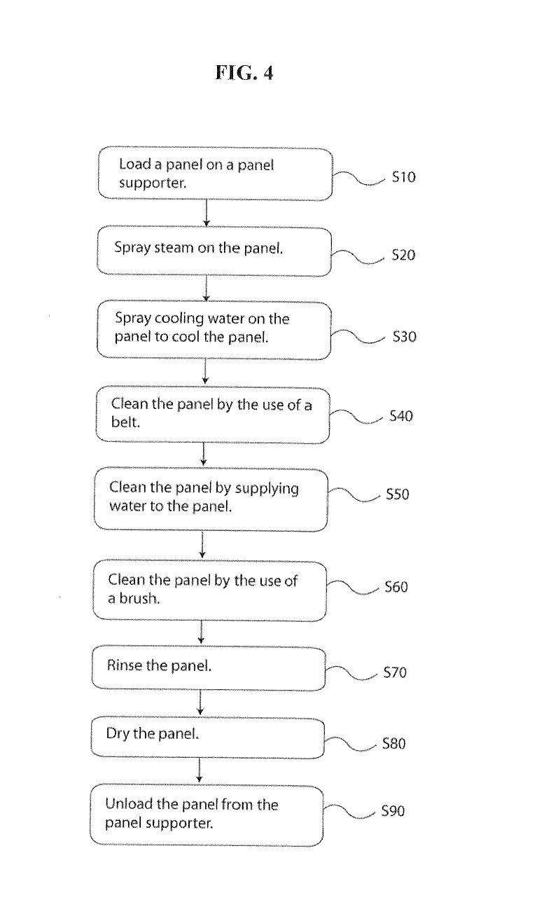

FIG. 3 shows an example for the configuration of the cleaning head 300 in a cleaning system for a panel according to another exemplary embodiment of the present disclosure.

In the exemplary embodiment shown in FIG. 3, the cleaning head 300 includes a steam sprayer 400, a cooling water sprayer 500, a belt cleaner 610, a pre-shower 620, a roll brush 630, a rinse part 640, and an air sprayer (or blade) 650.

Although not shown in the drawing, the cleaning head 300 may include a cleaning liquid sprayer. The cleaning liquid sprayer is connected with the cooling water sprayer 500, the belt cleaner 610, the pre-shower 620, or the roll brush 630 to spray the cleaning liquid on the panel when the cooling water sprayer 500, the belt cleaner 610, the pre-shower 620, or the roll brush 630 operates.

Efficiency in the cleaning may be improved by spraying the cleaning liquid on the panel by the cleaning liquid sprayer. The cleaning liquid discharged from the cleaning liquid sprayer may be a cleaning liquid in which a cleaning material is mixed with a solvent. The solvent may be water and may also be another solvent. The cleaning material may be a cleaning material which is generally known in the art. The kind of cleaning material is not limited and includes both a liquid cleaning material and a solid cleaning material. Those skilled in the art may select and use a proper cleaning material according to the need.

The steam sprayer 400, the cooling water sprayer 500, and the belt cleaner 610 are the same as described in the exemplary embodiment shown in FIG. 1.

The pre-shower 620 is a part for supplying water or the cleaning liquid to the panel after the belt cleaning is finished.

The roll brush 630 is a part including a brush, and is a part for cleaning the panel by using a roll type brush. While the panel is cleaned by the roll type brush included in the roll brush 630, the cleaning liquid or the water may be consistently applied to the panel.

The rinse part 640 is a part for cleaning the panel by supplying clean water to the panel that is cleaned by the roll brush 630. In an exemplary embodiment, the rinsing may be the final step of the cleaning.

The air sprayer 650 is a part for applying air on the panel after passing through the rinsing process. The air sprayer 650 may also be referred to as a drying part as a part for drying the panel by using air.

According to the exemplary embodiment of the present disclosure, the air sprayer 650 may include a blade for emitting air, and the air may be sprayed through the blade for air spraying.

The cleaning system according to the exemplary embodiment of the present disclosure is advantageous to the cleaning of the display panel. Accordingly, in the exemplary embodiment, the panels may be display panels. The cleaning system according to the exemplary embodiment of the present disclosure is useful in the cleaning of an organic light emitting diode display panel. Accordingly, the display panel according to the exemplary embodiment may be an organic light emitting diode display panel.

FIG. 1 schematically shows a process of cleaning the display panel by using the cleaning system according to the exemplary embodiment of the present disclosure.

A cleaning method of the panel shown in FIG. 1 includes loading the panel 100 to be cleaned on the panel supporter 200, spraying steam on the panel 100, spraying cooling water on the panel 100 where the steam is applied, and processing the panel 100 by a cleaning member. Herein, the processing of the panel by the cleaning member, for example, includes cleaning a belt by the belt cleaner 610.

In the case of performing the cleaning by using the cleaning system according to an exemplary embodiment of the present disclosure, either the panel supporter 200, on which the panel 100 is loaded, or the cleaning head 300 moves in a predetermined direction. Alternatively, the panel supporter 200 and the cleaning head 300 move in opposite directions to each other, while the cleaning is being performed.

Hereinafter, in the exemplary embodiment of the present disclosure, the case, in which the cleaning is performed while the cleaning head 300 is fixed in a position and the panel supporter 200 moves from the left to the right as represented by arrow in FIG. 1, will be described as an example.

Hereinafter, in the exemplary embodiment of the present disclosure, the case of cleaning the display panel as the panel is exemplified and particularly, the case of cleaning a panel of the organic light emitting diode display will be described as an example.

Referring to FIG. 1, although not shown in FIG. 1, after the panel 100 to be cleaned is loaded on the panel supporter 200, spraying of the steam is first performed.

The steam spraying is performed by the steam sprayer 400. A foreign substance attached to the panel may be temporarily swollen or may experience a phase change by the steam 401 emitted from the steam sprayer 400.

In the spraying of the steam, steam obtained by heating water is used. Among the water, particularly, deionized water (DI water) may be used. Meanwhile, the steam made by water mixed with a general cleaning material may be used, and for example, the steam made by evaporating a cleaning liquid, in which a surfactant and a chemical cleaning agent as the cleaning material are mixed with water, may also be used.

In the cleaning according to the exemplary embodiment, the spray pressure of the steam may be 1 bar or less, and the spray time of the steam may be about 1 to 20 seconds.

The steam is sprayed on the panel in a state where the temperature of the steam is controlled to be 50° C. to 100° C.

Spraying of the cooling water is performed on the panel after the spraying of the steam.

The spraying of the cooling water is a step for cooling the foreign substance of the panel, which was heated by the steam. That is, the foreign substance which is swollen or phase-changed by the steam spraying is cooled by the cooling water, and is condensed so that the coupling force with the panel is weakened.

The spraying of the cooling water is performed immediately after the steam spraying. That is, a continuous process is preformed so that the cooling water is sprayed immediately after the steam is sprayed to the panel and thus the foreign substance, which is heated by the steam to be swollen or phase-changed, is cooled.

Water of a relatively lower temperature is sprayed in the cooling water spraying. Among the water, particularly, deionized water (DI water) may be used. Meanwhile, water mixed with a cleaning material may be used, and for example, a cleaning liquid, in which a surfactant and a chemical cleaning agent as the cleaning material are mixed with water, may also be used.

In the cleaning method according to the exemplary embodiment, the cooling water can sufficiently cool the foreign substance attached to the panel, and is sprayed at a pressure that dose not damage the panel. Considering this characteristic, the spray pressure of the cooling water may be in the range of 0.5 to 1.5 kgf/cm².

The cooling water is sprayed until the swollen or phase-changed foreign substance can be sufficiently condensed. The spray time of the cooling water may be separately controlled according to the kind of foreign substance and a kind of panel. In the exemplary embodiment, considering characteristics of foreign substances generated from the organic light emitting diode display panel as the panel, the spray time of the cooling water may be about 1 to 10 seconds.

The temperature of the cooling water sprayed from the cooling water sprayer 500 may vary according to the kind of foreign substance, and the temperature of the cooling water becomes a temperature at which phase-changed or swollen foreign substance may be cooled. According to the exemplary embodiment of the present disclosure, the temperature of the cooling water sprayed from the cooling water sprayer 500 may be 0° C. to 20° C. Considering kinds, states, and the like of foreign substances attached to the panel, those skilled in the art may control the temperature of the cooling water in the range of the temperature.

As the processing of the panel by using the cleaning system, the cleaning shown in FIG. 1 includes belt cleaning by the belt cleaner 610.

In detail, the cleaning method of the panel according to the exemplary embodiment may include at least one of spraying a cleaning liquid, belt cleaning using the belt cleaner, and brushing using a brush, as the processing of the panel by the cleaning system, and the cleaning method of the panel according to the exemplary embodiment shown in FIG. 1 includes belt cleaning by the belt cleaner 610 included in the cleaning head 300.

The belt cleaning performs the cleaning by polishing the surface of the panel by using a belt wound around rollers, and included in the belt cleaner 610. In the belt cleaning, cleaning liquid may be sprayed. That is, the belt cleaning may be performed together with the spraying of the cleaning liquid. While the belt cleaning is performed, the cleaning liquid may be continuously sprayed or may be sprayed before the belt cleaning.

FIG. 4 shows a flowchart for processes of the cleaning method of the panel according to another exemplary embodiment of the present disclosure in stages.

The cleaning method in the exemplary embodiment shown in FIG. 4 includes loading a panel 100 to be cleaned on a panel supporter 200 (S10), spraying steam 401 on the panel 100 by a steam sprayer 400 (S20), cooling the panel 100 by spraying cooling water 501 on the panel where the steam is sprayed (S30), belt cleaning (S40), which may include cleaning the panel by the use of a belt, pre-showering (S50), which may include supplying water or the cleaning liquid to the panel to clean the panel, roll brushing using a roll type brush (S60), rinsing (S70), drying (S80), and unloading of the dried panel from the panel supporter 200 (S90).

The loading (S10), the steaming (S20), the cooling (S30), and the belt cleaning (S40) are the same as described in the cleaning method shown in FIG. 1.

The pre-showering (S50) is a step for supplying water or a cleaning liquid to the panel after the belt cleaning is finished. That is, before the roll brushing, the water or the cleaning liquid is applied to the panel in advance.

The roll brushing (S60) corresponds to the brushing using a brush. In the exemplary embodiment, the roll brushing (S60) is a step for cleaning the panel using the roll brush 630 which is the roll type brush as shown in FIG. 3. During the roll brushing, the cleaning liquid or the water may be continuously applied to the panel.

The rinsing (S70) is a step for cleaning the panel by supplying clean water to the panel which is cleaned through the roll brushing (S60). The rinsing (S70) may substantially correspond to the final step of the cleaning.

The drying (S80) is a drying step by spraying air to the panel through the rinsing (S70) by using the air sprayer 650. The drying using the air sprayer 650 may also be referred to as an air-cooling drying. The air sprayer 650 includes a blade for air spraying, and the air is sprayed through the blade for air spraying.

The unloading (S90) is a step of separating the panel dried through the drying (S80) from the panel supporter 200. Another process for additional processing may be performed on the separated panel of which the cleaning process is completed.

As described above, the exemplary embodiments of the cleaning system and the exemplary embodiments of the cleaning method of the panel according to the present disclosure were described. The exemplary embodiments are only the examples for describing the present disclosure and the scope of the present disclosure is not limited to the above-described exemplary embodiments and drawings.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A cleaning system for a panel, comprising:
a panel supporter on which the panel is loaded; and
a cleaning head disposed above the panel supporter, the cleaning head comprising:
a steam sprayer for spraying steam on the panel; and
a cooling water sprayer for spraying cooling water on the panel.

2. The cleaning system for a panel of claim 1, wherein the temperature of the steam sprayed from the steam sprayer is 50° C. to 100° C.

3. The cleaning system for a panel of claim 1, wherein the temperature of the cooling water sprayed from the cooling water sprayer is 0° C. to 20° C.

4. The cleaning system for a panel of claim 1, wherein the cleaning head further includes at least one of a cleaning liquid sprayer, a belt cleaner, and a brush.

5. The cleaning system for a panel of claim 1, further comprising:
a water tank, the steam sprayer being connected to the water tank, the steam sprayer comprising:
a pump for drawing water from the water tank;
a heating apparatus for heating the water supplied from the pump to generate steam; and
a steam spraying nozzle for spraying the steam.

6. The cleaning system for a panel of claim 1, further comprising:
an air sprayer for applying air to the panel.

7. The cleaning system for a panel of claim 6, wherein the air sprayer includes a blade for emitting air.

8. The cleaning system for a panel of claim 1, wherein the panel is a display panel.

9. The cleaning system for a panel of claim 8, wherein the display panel is an organic light emitting diode display panel.

10. A cleaning method of a panel, comprising:
loading the panel on a panel supporter;
spraying steam on the panel;
spraying cooling water on the panel after the spraying steam; and
processing the panel by a cleaning member.

11. The cleaning method of a panel of claim. 10, wherein the spraying of the cooling water is continuously performed after performing the spraying of the steam.

12. The cleaning method of a panel of claim 10, wherein the temperature of the steam sprayed in the spraying of the steam is 50° C. to 100° C.

13. The cleaning method of a panel of claim 10, wherein the spray time of the steam sprayed in the spraying of the steam is 1 second to 20 seconds.

14. The cleaning method of a panel of claim 10, wherein the temperature of the cooling water sprayed in the spraying of the cooling water is 0° C. to 20° C.

15. The cleaning method of a panel of claim 10, wherein the spray time of the cooling water sprayed in the spraying of the cooling water is 1 second to 10 seconds.

16. The cleaning method of a panel of claim 10, wherein the spray pressure of the cooling water sprayed in the spraying of the cooling water is 0.5 kgf/cm² to 1.5 kgf/cm².

17. The cleaning method of a panel of claim 10, wherein the processing of the panel by the cleaning member includes a method selected from the group consisting of spraying a cleaning liquid, belt cleaning using a belt cleaner, brushing using a brush, and combinations thereof.

18. The cleaning method of a panel of claim 10, further comprising:
spraying air on the panel.

19. The cleaning method of a panel of claim 10, wherein the panel is a display panel.

20. The cleaning method of a panel of claim 19, wherein the display panel is an organic light emitting diode display panel.
